(19) United States
(12) Patent Application Publication
(10) Pub. No.: US 2017/0109785 A1
(43) Pub. Date: Apr. 20, 2017

(54) PROVIDING CONTENT WITH BRANDING LABELS

(71) Applicant: Google Inc., (US)

(72) Inventor: Ezequiel Vidra, London (GB)

(73) Assignee: Google Inc., Mountain View, CA (US)

(21) Appl. No.: 13/754,738

(22) Filed: Jan. 30, 2013

(51) Int. Cl. G06Q 30/00

(52) U.S. Cl. CPC G06Q 30/0256

(57) ABSTRACT

Methods, systems, and computer program products are provided for providing content items with branding labels. One example method includes receiving a request for a content item to be presented to a user, identifying the content item from eligible content items, evaluating the content item to determine if the content item includes content that is associated with a branding label including identifying an appropriate branding label for the content item, applying the branding label to the content item, and providing the content item along with the branding label responsive to the request.

### BACKGROUND

This specification generally relates to information presentation.

Users can employ Internet-based search engine interfaces to provide search queries and to receive query results. Content providers can select specific search query keywords, and can sponsor content to be provided to users along with the query results. Sponsored content provided by some search engines may include product images. Some sponsored content may include ratings (e.g., star ratings) which may potentially influence click-through rates by users.

### SUMMARY

In general, one innovative aspect of the subject matter described in this specification may be embodied in methods, systems, and computer program products for providing content items with branding labels. One example method includes receiving a request for a content item to be presented to a user, identifying the content item from eligible content items, evaluating the content item to determine if the content item includes content that is associated with a branding label including identifying an appropriate branding label for the content item, applying the branding label to the content item, and providing the content item along with the branding label responsive to the request.

In general, another innovative aspect of the subject matter described in this specification may be embodied in computer program products that can perform operations including receiving a request for a content item to be presented to a user, identifying the content item from eligible content items, evaluating the content item to determine if the content item includes content that is associated with a branding label including identifying an appropriate branding label for the content item, applying the branding label to the content item, and providing the content item along with the branding label responsive to the request.

In general, another innovative aspect of the subject matter described in this specification may be embodied in content management systems for serving sponsored content to users. The systems can include request receivers, content item identifiers, content item evaluators, branding label applicators, and content item providers. A request receiver can receive a request for a content item to be presented to a user. A content item identifier can identify a content item from eligible content items. A content item evaluator can evaluate a content item to determine if the content item includes content that is associated with a branding label including identifying an appropriate branding label for the content item. A branding label applicator can apply a branding label to a content item. A content item provider can provide a content item along with a branding label responsive to a request.

These and other embodiments may each optionally include none, one or more of the following features. The content item can include only text and the branding label can be an image. The branding label can be a trademark or service mark. Evaluating the content item can include identifying one or more products or services associated with the content item, and identifying an appropriate branding label for the content item can include identifying a branding label associated with the identified products or services. Evaluating the content item can include evaluating textual elements in the content item to identify the one or more products or services associated with the content item. Evaluating the content item can include identifying one or more trademarks included in the content item. A source of the content item and an owner associated with the branding label can be identified, and applying the branding label to the content item can occur when the source of the content item matches the owner associated with the branding label. A quality score associated with the content item can be adjusted if the content item is associated with a branding label, and applying the branding label to the content item and providing the content item along with the branding label can be subject to the content item being selected as part of an auction. Adjusting the quality score can include raising the quality score. Prior to applying the branding label to the content item, a determination can be made of whether a sponsor associated with the content item has designated that a branding label should be applied if available, and the branding label can be applied based on the determination. The content item can be an advertisement. A dataset of branding labels can be stored and indexed by associated products or services. Evaluating the content item to determine if the content item includes content that is associated with a branding label can include evaluating the dataset. The content item can be a textual advertisement and the branding label can be an image. Applying the branding label to the content item can include determining a location on the content item to place the branding label. Determining the location can include determining an acceptable location based on sponsor input. Determining the location can include determining an acceptable location that minimizes a portion of the content item that is obscured.

Particular embodiments of the subject matter described in this specification may be implemented to realize none, one or more of the following advantages. Entities (e.g., organizations, businesses, individuals, etc.) with an established brand can differentiate their sponsored content from content provided by other entities. Entities can protect their brand identification from unauthorized use.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of an example environment for presenting content to users in response to requests for content.

FIG. 2 is a diagram of an example system that can provide content items with branding labels.

FIG. 3 shows an example user interface for presenting campaign sponsors with options for specifying branding labels to be provided with content items.

FIG. 4 is a flowchart of an example process for identifying an appropriate branding label for a content item and providing the content item along with the branding label.

FIG. 5 shows an example of a computer device and a mobile computer device that can be used to implement the techniques described herein.

Like reference symbols in the various drawings indicate like elements.

### DETAILED DESCRIPTION

In general, computer systems can provide selected content based on receipt of content requests. For example, users can interact with a search engine interface (e.g., a web page) and provide queries via a search control (e.g., a search box). A content sponsor (e.g., an advertiser) can create a campaign that includes content and keywords that are used to determine when to serve the content responsive to received requests. A content sponsor can be given the option to have appropriate branding labels (e.g., favicons, graphics, etc.) applied to the content items when appropriate.

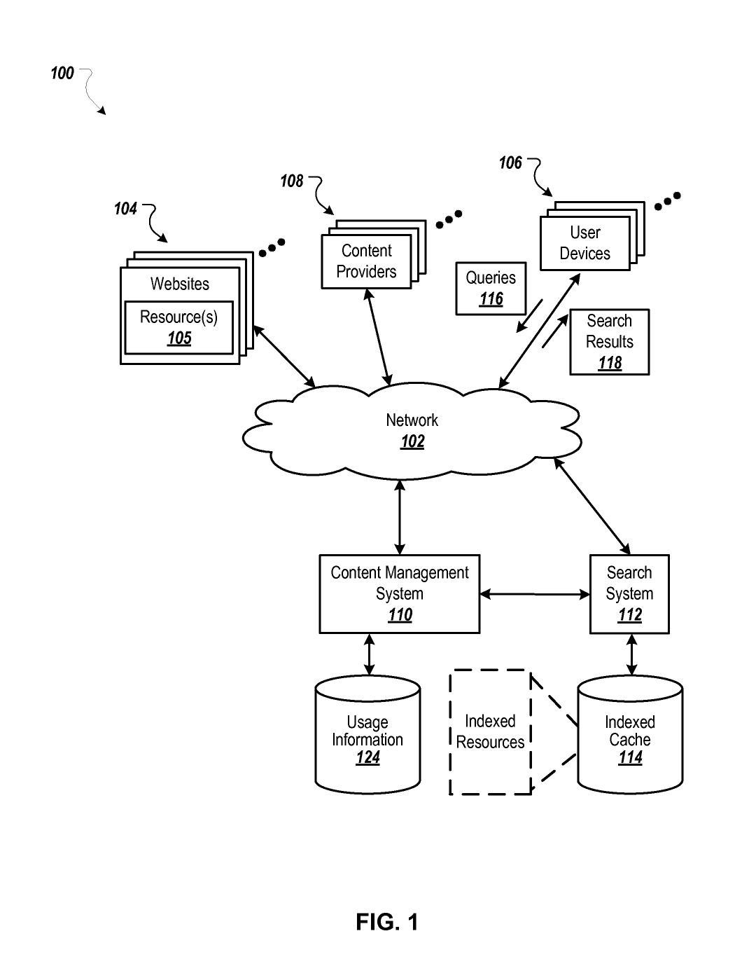

FIG. 1 is a block diagram of an example environment 100 for providing content to users in response to requests for content. The example environment 100 includes a network 102, such as a local area network (LAN), a wide area network (WAN), the Internet, or a combination thereof. The network 102 connects websites 104, user devices 106, content providers 108 (e.g., advertisers), publishers, and a content management system 110. The example environment 100 may include many thousands of websites 104, user devices 106, and content providers 108. The content management system 110 may be used for selecting and providing content in response to requests for content.

A website 104 includes one or more resources 105 associated with a domain name and hosted by one or more servers. An example website 104 is a collection of web pages formatted in hypertext markup language (HTML) that can contain text, images (e.g., .GIFs, .JPGs, .PNGs, etc.), multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, images and sounds, that may include embedded information (such as meta-information hyperlinks) and/or embedded instructions (such as scripts).

To facilitate searching of resources 105, the environment 100 can include a search system 112 that identifies the resources 105, for example, by crawling and indexing the resources 105 provided by the content publishers on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. User devices 106 can also submit search queries 116 to the search system 112 over the network 102. A request for a resource 105 or a search query 116 sent from a user device 106 can include an identifier, such as a cookie, identifying the requesting source (e.g., a device or user identifier).

In response to a search query 116, the search system 112 can access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The content information system 110 can update usage information 124 for a user, based on activity of the user, and in some implementations, subject to the user's express permission. Certain data may be anonymized in one or more ways before it is stored or used. The usage information 124 can include, for example, information about past user activities, such as past requests for resources 105, past search queries 116, other requests for content, websites visited, or interactions with content. In some implementations, the usage information 124 can be derived, for example, from one or more of a query log, an advertisement log, or requests for content. In some implementations, the usage information 124 can include, for each entry, a cookie, a timestamp, an IP (Internet Protocol) address associated with a requesting user device 106, a type of usage, and details associated with the usage.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

When a resource 105 or search results 118 are requested by a user device 106, the content management system 110 may receive a request for content to be provided with the resource 105 or search results 118. The request for content can include characteristics of one or more “slots” that are defined for the requested resource 105 or search results page. For example, the data representing the resource 105 can include data specifying a portion of the resource 105 or a portion of a user display, such as a presentation location of a pop-up window or a slot of a third-party content site or web page or a designated portion of a user interface associated with a search control, in which content can be presented. An example slot is an ad slot. Search results pages can also include one or more slots in which other content items (e.g., ads) can be presented.

Information about slots can be provided to the content management system 110. For example, a reference (e.g., URL) to the resource for which the slot is defined, a size of the slot, and/or media types that are available for presentation in the slot can be provided to the content management system 110. Similarly, keywords or portions of keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords (or portions of keywords) or search queries 116. As another example, content items having serving keywords that match the resource keywords (or portions thereof) or the search query 116 are selected as eligible content items by the content management system 110.

A serving keyword can match a resource keyword or a search query 116 by having the same textual content (“text”) as the resource keyword or search query 116. For example, a content item (e.g., an advertisement) associated with the serving keyword “automobiles” can be an eligible content item (or an eligible ad) for a content item request that includes the resource keyword “automobiles.” Similarly, the ad can be selected as an eligible content item for a request including the search query term “automobiles.” Moreover, partial keyword forms, or “prefixes”, may be considered when matching serving keywords with resource keywords or search queries. For example, a content item associated with a partial form of a serving keyword (e.g., the letter “a”, the partial form “au”, the partial form “aut”, etc.) can be selected as an eligible content item for a request including similar partial resource keywords or partial search queries.

The content management system 110 can select from the eligible content items that are to be provided for presentation in slots of a resource 105 or search results page 118 based at least in part on results of an auction. For example, for the eligible content items, the content management system 110 can identify bids from content providers 108 (e.g., advertisers) and allocate the slots, based at least in part on the received bids (e.g., based on the highest bidders at the conclusion of the auction). The bids are amounts that the content providers are willing to pay for presentation of (or interaction with) their content with a resource 105 or search results page 118. For example, a bid can specify an amount that a content provider is willing to pay for each one thousand impressions (i.e., presentations) of the content item, referred to as a CPM bid. Alternatively, the bid can specify an amount that the content provider is willing to pay for a selection (i.e., a click-through) of the content item or a conversion (or other action) following selection of the content item. The selected content item can be determined based on the bids alone, or based on the bids of each bidder being multiplied by one or more factors, such as quality scores derived from content performance, landing page scores, and/or other factors.

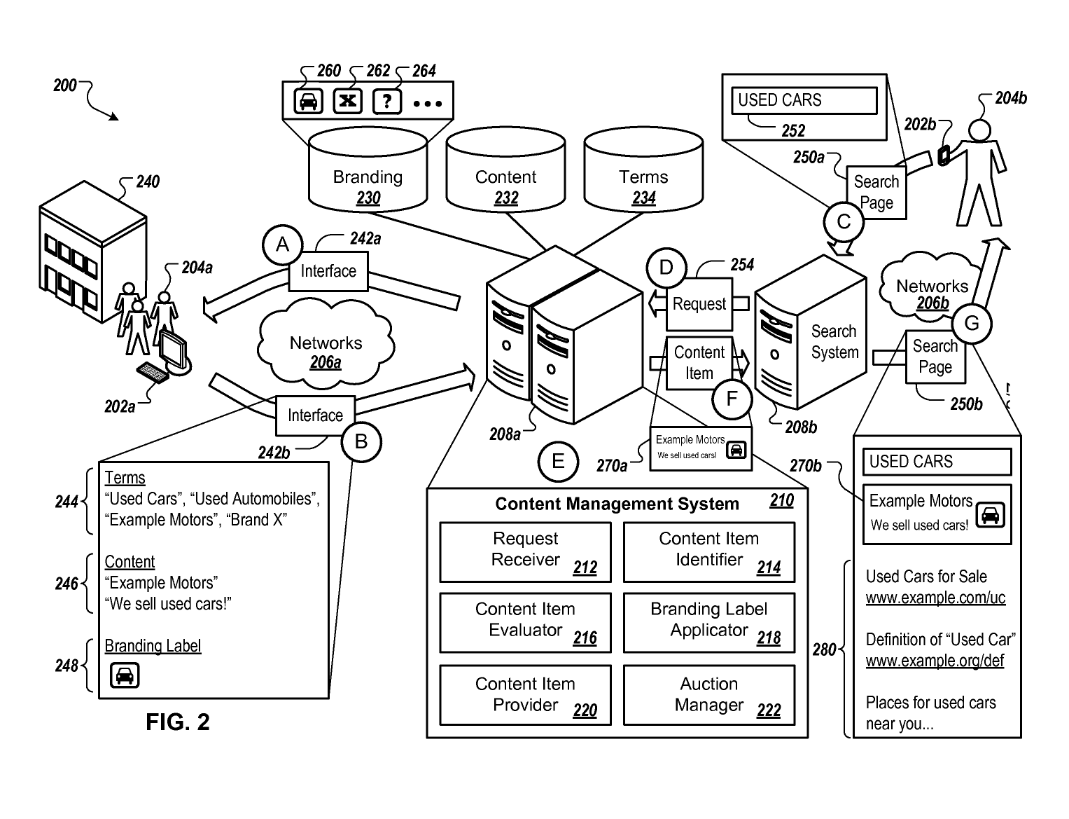

FIG. 2 is a diagram of an example system 200 that can provide content items with branding labels. FIG. 2 also illustrates an example flow of data within the system 200 during states (A) to (G), where the states (A) to (G) may occur in the illustrated sequence, or they may occur in a sequence that is different than in the illustrated sequence. For example, two or more of the states (A) to (G) may occur concurrently.

The system 200 can include one or more client devices 202 (each operated by a corresponding device user 204) that communicate over one or more networks 206 with one or more computing servers 208. The networks 206 may include a wireless cellular network, a wireless local area network (WLAN) or WiFi network, a Third Generation (3G) or Fourth Generation (4G) mobile telecommunications network, an intranet, the Internet, or any other suitable network or any appropriate combination thereof.

The client device(s) 202 may be any suitable type of computing device (e.g., mobile phone, smartphone, personal digital assistant, tablet computer, laptop or desktop computer, or other stationary or portable device) that includes one or more processors and computer readable media. Among other components, for example, the client device(s) 202 includes one or more processors, computer readable media that store software applications, input device(s) (e.g., touch screens, keyboards, computer mice, motion sensors, microphones, etc.), output device(s) (e.g., display screens, speakers, etc.), and communications interfaces.

The computing server(s) 208 may be configured to execute application code associated with a variety of software components (e.g., modules, objects, libraries, services, etc.), including computer instructions to perform some or all of the method steps described below. In some implementations, the computing server 208a may include one or more components of the content management system 210 described below.

The content management system 210 (e.g., similar to the content management system 110, shown in FIG. 1) can receive a request for a content item to be presented to a user, identify a responsive content item (e.g., through an auction), evaluate the content item to determine if the content item includes content that is associated with a branding label, apply the branding label, and provide the content item along with the branding label responsive to the request. In the present example, the content management system 210 includes a request receiver 212, a content item identifier 214, a content item evaluator 216, a branding label applicator 218, a content item provider 220, and an auction manager 222. Two or more of the components 212, 214, 216, 218, 220, and 222 may be implemented on the same device (e.g., same computing device), or on different devices, such as devices included in a server farm or a peer-to-peer network.

The content management system 210 may be in communication with one or more data stores, servers, and/or other systems. In the present example, the content management system 210 and server(s) 208a can communicate with a branding data store 230, a content data store 232, a terms data store 234, and with the server(s) 208b (e.g., servers for running a search system, similar to the search system 112 shown in FIG. 1). The data stores 230, 232, and 234, for example, can implement databases, file systems, and other suitable mechanisms to add, remove, and maintain data used by the system 200. The server(s) 208b (the search system), for example, can receive search queries from and can provide search results to system users (e.g., the user 204b).

Referring to the example flow of data, during state (A), a campaign sponsor can be presented with options to define and specify content items for presentation to users and/or to provide information related to branding labels to be applied to content items. Campaigns, for example, may include actions for reaching users, or particular categories (e.g., based on locations, languages, and/or profiles) of users. Campaign sponsors, for example, may include entities (e.g., organizations, individuals, businesses, advertisers) that intend to provide content items (e.g., advertisements) to system users (e.g., the user 204b) as specified by one or more campaigns.

In the present example, the content management system 210 can provide content definition and branding options to the user 204a (e.g., a representative of campaign sponsor 240) via an interface 242 (shown here as interface 242a). The user 204a, for example, may be a representative, agent, and/or employee of campaign sponsor 240 (e.g., “Example Motors”, an automobile dealership). The interface 242, for example, may be an online interface (e.g., a web page, a web application, etc.) provided by the content management system 210, and may include various controls for presenting information to and receiving information from campaign sponsors via networks 206a, to facilitate campaign configuration and management by the sponsors.

During state (B), campaign information can be received from a campaign sponsor. In the present example, to provide campaign information to the content management system 210, the user 204a can employ the client device 202a to interact with the interface 242 (shown here as interface 242b). For example, the user 204a can use the interface 242b to provide campaign information including one or more term selections 244, one or more content items 246, and one or more branding labels 248 to be used by the content management system 210 when selecting content items for presentation to users. Term selections, for example, may include phrases (multiple terms), single terms, and/or partial forms (e.g., prefixes) of one or more terms. In the present example, the term selections 244 indicated by the user 204a include the phrases “Used Cars”, “Used Automobiles”, “Example Motors”, and “Brand X”. Content items, for example, may include text, images, video, audio, web links, and other types of content. In the present example, the content items 246 indicated by the user 204a include the text phrases “Example Motors” and “We sell used cars!” Branding labels, for example, may include graphics, images, icons, favicons (i.e., short cut icons associated with a particular website or web page), trademarks, service marks, or other appropriate indicators associated with a campaign sponsor, or with a product or service associated with the campaign sponsor. In some implementations, branding labels may include one or more interactive elements. For example, a branding label may be configured to respond to user interaction (e.g., a mouse hover, a click, etc.), changing from one state to another (e.g., a visual change, a sound effect, etc.) based on the interaction. In some implementations, the branding labels can be provided to designate source, origin or sponsorship of the content presented.

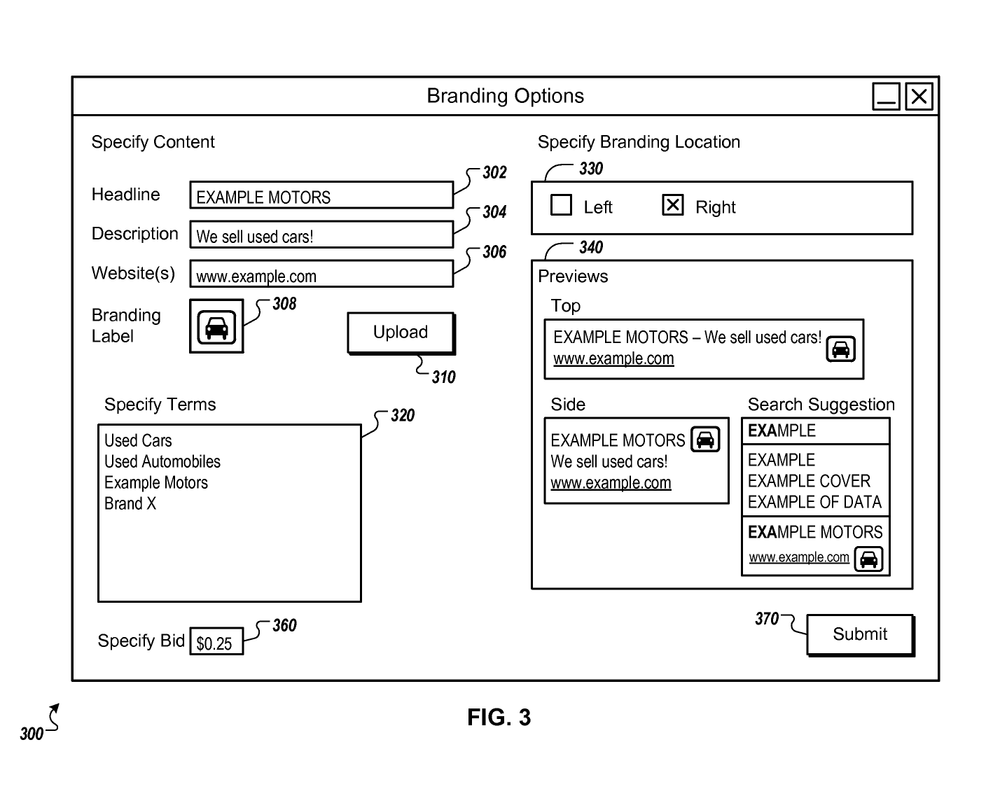

As described in additional examples below (refer to FIG. 3), in some implementations, the interface 242 may provide options for providing campaign information such as content item text placement (e.g., headlines, descriptions, etc.), web links, branding label locations, auction bid values, etc. Upon receiving the term selection(s) 244, content item(s) 246, branding label(s) 248, and other campaign information provided by the user 204a, for example, the content management system 210 can associate the provided campaign information with a campaign of the campaign sponsor 240. For example, the term selection(s) 244 can be maintained by the terms data store 234, the content item(s) 246 can be maintained by the content data store 232, and the branding label(s) 248 can be maintained by the branding data store 230, in association with one or more campaign identifiers (e.g., data keys).

During state (C), systems (or users) can submit requests for content. Requests for content, for example, may include search queries, map requests, social network requests, web page requests, and other types of content requests. Requests may be submitted, for example, by providing text (e.g., by typing), voice commands, images (e.g., photos), and other suitable mechanisms. In the present example, the user 204b can employ the client device 202b to access a search page 250 (shown here as search page 250a) provided by the server(s) 208b (the search system) via networks 206b. Interacting with the search page 250a, for example, the user 204b can enter (e.g., via keypad) a query (e.g., the search text “used cars”) in a search control 252. As the user 204b enters the sequence of letters included in the search text “used cars”, for example, the search page 250a can provide the sequence to the server(s) 208b. As another example, the user 204b may interact with (e.g., click) a control (e.g., a command button) indicating that search text has been entered and is to be provided to the search system, upon completion of the search text entry. Upon receiving the complete or partial search text, for example, the server(s) 208b (the search system) may generate search results, and may provide to the content management system 210 a request 254 for one or more content items (e.g., advertisements) to be presented to the user 240b via the client device 202b, along with generated search results.

During state (D), a request for a content item to be presented to a user can be received. For example, the content management system 210 can use the request receiver 212 (e.g., an application programming interface (API) or another suitable interface for communication between system components) to receive the request 254 for one or more content items to be presented to the user 204b via the client device 202b. A request for a content item, for example, may include information related to the context of the request, a type of user associated with the request, and/or a computing device employed by a user. For example, upon receiving express permission from the user 204b, the computing servers 208a (i.e., servers used by the content management system 210) and 208b (i.e., the search system) may employ information associated with the user 204b and/or the client device 202b to provide search results and/or selected content (e.g., content items, advertisements, etc.) responsive to the request 254, and of possible relevance to the particular user 204b, suitable for presentation on the client device 202b. In the present example, the request context may be that of a search query including search text (e.g., “used cars”) provided by the user 204b. Information related to the user 204b, for example, may include information such as the user's language preferences and/or interests. Information related to the computing device 202b employed by the user 204b, for example, may include information such as the device's geographical location (e.g., as determined by user input, an Internet service provider, a Global Positioning System (GPS), etc.), the device's model information, browser information and/or the device's capabilities (e.g., input devices, output devices, processing devices, etc.).

During state (E), a request for a content item to be presented to a user can be processed. For example, the content management system 210 can process the request 254, based on information (e.g., request context, audience information, device information, etc.) associated with the request. Upon receiving the request 254, for example, the content management system 210 can use the content item identifier 214 to identify a content item from eligible content items. Considering the search text (e.g., “used cars”) provided by the user 202b and included in the request 254, for example, the content item identifier 214 can access the terms data store 234 to determine whether one or more terms included in the search text match one or more terms associated with any campaign (e.g., a campaign of the campaign sponsor 240 or that of another campaign sponsor). In the present example, the phrase “used cars” may be identified as matching one or more term selections 244 provided in association with a campaign of the campaign sponsor 240. Upon determining a match (e.g., complete or partial match), for example, the content item identifier 214 may use a campaign identifier (e.g., a data key) to access the content data store 232 to identify one or more content items provided by the campaign sponsor 240 for the campaign. Content items, for example, may include text, images, video, audio, web links, and other types of content specified by a campaign sponsor and/or generated by the content management system 210. In the present example, the content item identifier 214 may identify the content items 246 (e.g., the text phrases “Example Motors” and “We sell used cars!”) associated with a campaign of the campaign sponsor 240. If multiple campaigns are identified, for example, then a selection (e.g., an auction or reservation selection) can be made to determine which among the multiple eligible items should be delivered.

In some implementations, an auction may be run, and content may be selected in accordance with one or more auction winners. For example, the content management system 210 can use the auction manager 222 to evaluate bids provided by various campaign sponsors for having content presented to users in response to content requests. Campaign sponsors, for example, may bid on various phrases, terms, and/or prefixes that may be entered by users (or that may be suggested by the search system). During an auction, for example, the auction manager 222 can evaluate bids and associated quality scores for candidate content items, and can determine one or more auction winners. Quality scores, for example, may be based on historical click rates and/or other suitable factors.

A content item can be evaluated to determine if the content item includes content that is associated with a branding label. For example, the content management system 210 can use the content item evaluator 216 to evaluate the content items 246 (e.g., the text phrases “Example Motors” and “We sell used cars!”) to determine if they include content that is associated with a branding label, and if so, to identify an appropriate branding label for the content item(s). In the present example, the content management system 210 may determine that the content items 246 were provided by the campaign sponsor 240, and that the campaign sponsor 240 also provided a branding label 248. Thus, the content item evaluator 216 can access the branding data store 230 to identify and provide the branding label (shown here as branding label 260, a favicon including a graphic of an automobile) to the content management system 210.

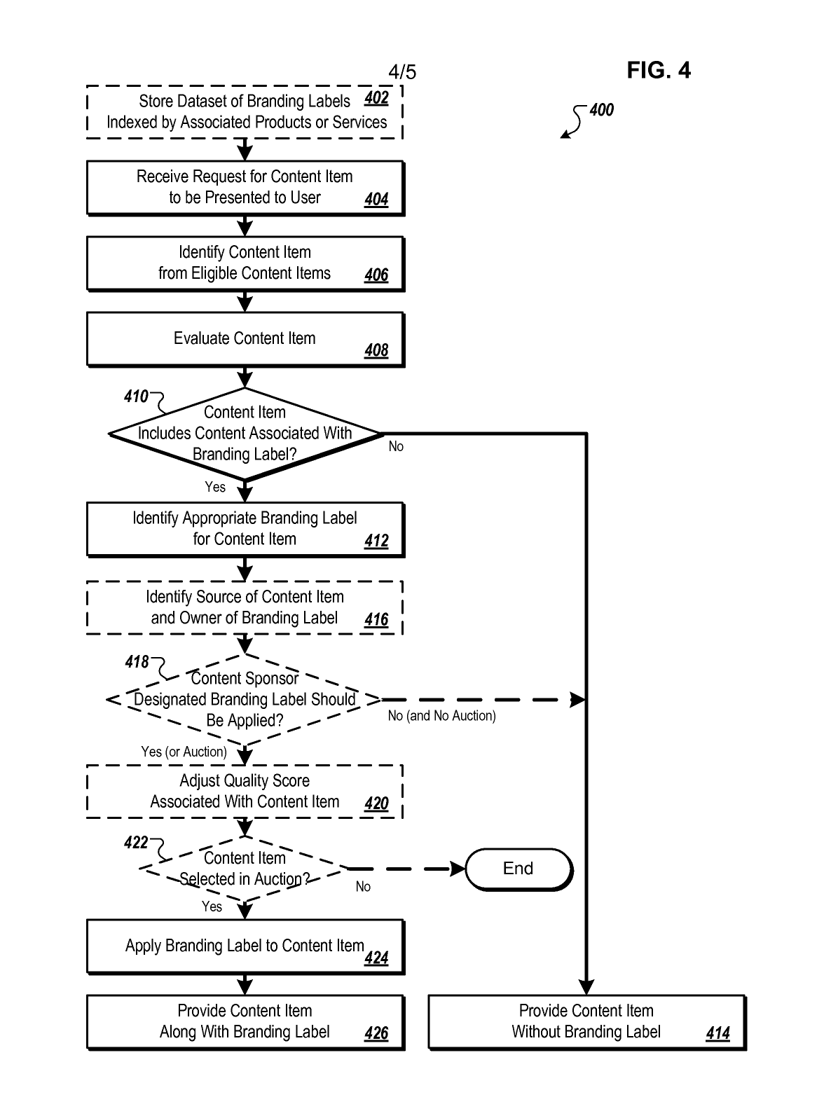

A branding label can be applied to a content item. For example, the content management system 210 can use the branding label applicator 218 to apply the branding label 260 to the content items 246 to generate a composite content item 270 (shown here as content item 270a). Composite content items, for example, may include one or more integrated text, image, video, audio, and/or link elements, and may be formatted by the content management system 210 for presentation to users (e.g., the system user 204b) by applications (e.g., web browsers, custom applications, etc.) executed by client devices (e.g., the client device 202b). Various techniques may be used by the content management system 210 to determine whether branding labels should be associated with content items, to identify appropriate branding labels, and to apply branding labels to content items, as described in additional examples below (e.g., see FIG. 4.)

During state (F), a content item can be provided along with a branding label responsive to a request. For example, the content management system 210 can use the content item provider 220 (e.g., an application programming interface or another suitable interface for communication between system components) to provide the composite content item 270 (shown here as content item 270a) to the computing server(s) 208b (the search system), responsive to the request 254. Upon receiving the composite content item 270a, for example, the computing server(s) 208b can integrate the content item with other content (e.g., a web page, a set of search results, a map, a video, an article, a social networking feed, etc.) requested by the user 204b. Placement (e.g., location, timing, etc.) of the content item 270, for example, may be determined by the content management system 210, the computing server(s) 208b, and/or by information provided by a representative of the campaign sponsor 240.

During state (G), content can be presented to a user. For example, the server(s) 208b (the search system) can include the composite content item 270 (shown here as content item 270b) on the search page 250 (shown here as search page 250b) along with search results 280 for presentation to the user 204b via the client device 202b. The composite content item 270b, for example, may be provided in a standard slot (e.g., on the right rail of a web page, at the bottom of a mobile application, etc.), and/or may be provided within the search control 252 (e.g., in response to a partial query match). The search results 280 and the composite content item 270, for example, may be relevant for the search text (e.g., “used cars”) entered by the user 204b via the search control 252, and may be provided based at least in part on attributes of the user 204b and/or the client device 202b. For example, the user 204b and/or the client device 202b may be located in proximity to the campaign sponsor 240 (e.g., “Example Motors”). Thus, in the present example, if the user 204b happens to be interested in “Example Motors”, he or she may readily identify the composite content item 270b as being sponsored by “Example Motors” by its branding label, and may interact with (e.g., click) the content item 270b to navigate his or her web browser to the campaign sponsor's website.

FIG. 3 shows an example user interface 300 for presenting campaign sponsors with options for specifying branding labels to be provided with content items. For example, the client device 202a (shown in FIG. 2) can execute an application such as a web browser to present to the user 204a (e.g., a representative of campaign sponsor 240) one or more user interfaces, such as the user interface 242 (also shown in FIG. 2) or the user interface 300. By interacting with user interfaces such as the user interfaces 242, 300, for example, representatives of the campaign sponsor 240 can provide criteria for use in applying branding labels to content items for presentation to users.

Referring to FIG. 3, the example user interface 300 may include one or more controls for specifying content items (e.g., advertisements) to be presented to users. For example, the user interface 300 may include a control 302 for indicating a headline, a control 304 for indicating a description, a control 306 for indicating a web link, and a control 308 for indicating a branding label to be associated with or included in a composite content item. In the present example, a representative (e.g., the user 204a) of the campaign sponsor 240 can interact with (e.g., enter a value in) the control 302 to provide the headline “EXAMPLE MOTORS”, can interact with the control 304 to provide the description “We sell used cars!”, and can interact with the control 306 to provide the web link “www.example.com”. Interacting with the control 308 and/or a control 310, for example, the representative can provide (e.g., upload) and/or create (e.g., draw) a branding label (e.g., an icon, such as the campaign sponsor's logo) or another sort of graphic or content (e.g., visual or audio). In some implementations, stock graphics or content may be provided. The content management system 210, for example, can provide stock graphics or other content to campaign sponsor representatives for use (e.g., as a component, base, or template) in creating branding labels. In some implementations, uploaded and/or created branding labels may adhere to a published specification (e.g., size, format, etc.), or may be converted by the content management system 210 to follow such a specification. Consistently sized and/or formatted branding labels, for example, may be used by the content management system 210 to facilitate label application.

In some implementations, submitted (e.g., created and/or uploaded) branding labels may be subjected to automated and/or manual review to determine whether the labels include protected or potentially inappropriate content. Upon receiving a branding label, for example, the content management system 210 can use the content item evaluator 216 to employ automated image, audio, and/or video recognition techniques to determine whether the submitted branding label includes protected (e.g., trademarked, copyrighted, etc.) content, and if so, whether the submitter is authorized to use the content. As another example, the submitted branding label may be stored and queued for manual review.

Upon determining whether the branding label is approved (i.e., use of the label is authorized and the label is appropriate) or rejected (i.e., use of the label is unauthorized or the label is inappropriate), for example, the content management system 210 can provide notification (e.g., a message) of the determination to a representative (e.g., the user 204a) of a campaign sponsor. In some implementations, approval or rejection of a branding label may occur upon submission of the branding label. When the user 204a submits the branding label 260, for example, the content management system 210 can initiate an evaluation process for the submitted branding label. In some implementations, a determination of whether a branding label includes protected or potentially inappropriate content may occur prior to a decision of whether to apply the branding label to a content item. Before generating the composite content item 270a, for example, the content management system 210 can determine whether the branding label 260 is protected or potentially inappropriate, as a discrete unit, or in combination with one of the content items 246. Such a determination may be performed immediately prior to the application, for example, or may be performed periodically (e.g., as a batch process) on a corpus of branding labels.

The example user interface 300 may include one or more controls for specifying terms (e.g., phrases, keywords, keyword prefixes, etc.) associated with a campaign. For example, the user interface 300 may include a control 320 for indicating terms to be used for servicing and selecting content items. In the present example, a representative of the campaign sponsor 240 can interact with (e.g., enter text in) the control 320 to provide the phrases “Used Cars”, “Used Automobiles”, “Example Motors” and “Brand X”. Upon receiving provided terms via the interface 300, for example, the content management system 210 can associate the provided terms with the sponsor's campaign (e.g., by updating information maintained by the terms data store 234).

The example user interface 300 may include one or more controls for specifying placement of branding labels on content items associated with a campaign. For example, the user interface 300 may include a control 330 for indicating that a branding label is to be applied within a particular portion (e.g., left, right, top, bottom, etc.) of a composite content item to be presented to system users (e.g., the user 204b). As another example, the user interface 300 may include one or more controls (not shown) for facilitating refined placement of branding labels on content items, such as drag and drop controls facilitating the interactive placement and/or sizing of branding labels within a composite content item preview. In the present example, the representative of the campaign sponsor 240 may interact with the control 330 to indicate that the branding label indicated by the control 308 is to be applied to the right side of a content item including content provided by use of the controls 302, 304, and 306.

In some implementations, composite content item previews may be provided. For example, the user interface 300 may include a control 340 for providing to a representative of the campaign sponsor 240 a preview of how a specified composite content item with an applied branding label would appear to a system user (e.g., the user 204b) when presented within a top portion of a content presentation interface (e.g., the search page 250b), a side portion of the content presentation interface, or within a search suggestion control. As another example, composite content item previews may be provided for content items associated with other content formats, such as video formats, audio formats, etc.

The user interface 300, for example, may include one or more controls for specifying information to be used in an auction for having content items presented to system users. For example, the user interface 300 may include a control 360 for specifying a bid value. In the present example, a representative of the campaign sponsor 240 may interact with the control 360 to indicate a default bid of $0.25 for having content items presented to users in response to receipt of campaign terms (e.g., phrases, keywords, keyword prefixes, etc.), and for having a branding label (e.g., the branding label indicated by the control 308) applied to the content item.

More or fewer controls may be presented to campaign sponsor representatives for providing campaign information, content item specification, branding label specification, and/or selection criteria. For example, an interface for specifying selection criteria may include one or more controls for specifying preferred audience characteristics, such as audience demographics, language, location, and other suitable characteristics. As another example, an interface for content item specification and branding label specification may include one or more controls for providing further instructions for applying branding labels to content items, such as specifications for transparency, highlighting, delay, fading, etc. Upon specifying desired campaign information, content item and branding label specification, and selection criteria, for example, a representative of the campaign sponsor 240 can interact with (e.g., click) a control 370 to submit information to the content management system 210.

FIG. 4 is a flowchart of an example process 400 for identifying an appropriate branding label for a content item and providing the content item along with the branding label. In some implementations, the process 400 may be performed by the systems 100 (shown in FIG. 1) and/or 200 (shown in FIG. 2), and will be described as such for the purpose of clarity. Briefly, the process 400 may include receiving a request for a content item to be presented to a user, identifying the content item from eligible content items, evaluating the content item to determine if the content item includes content that is associated with a branding label (including identifying an appropriate branding label for the content item), applying the branding label to the content item, and providing the content item along with the branding label responsive to the request.

In some implementations, a dataset of branding labels indexed by associated products or services may be stored (402). Referring to FIG. 2, for example, a variety of branding labels (e.g., branding labels 260, 262, 264, etc.) may be stored by the branding data store 230. In the present example, branding label 260 (e.g., a label including a graphic of an automobile) may be associated with products and services provided by the campaign sponsor 240 (e.g., “Example Motors”), branding label 262 (e.g., a label including a graphic of the letter “X”) may be associated with “Brand X”, an automobile brand, and branding label 264 (e.g., a label including a graphic of a question mark) may be associated with “Unknown Vehicle Services”, an automobile service center. For example, representatives of each of the product and service providers “Example Motors”, “Brand X”, and “Unknown Vehicle Services” may provide (e.g., via the interface 242, shown in FIG. 2 or via the interface 300, shown in FIG. 3) branding labels to the content management system 210. As another example, the content management system 210 may reference public sources of information (e.g. trademark databases, etc.) to identify branding labels and associated entities, products, and services.

A request for a content item to be presented to a user can be received (404). In general, various types of computer systems may request content items from the content management system 210. In the present example, the content management system 210 can use the request receiver 212 to receive the request 254 from the server(s) 208b (the search system) for one or more textual content items (e.g., advertisements) for presentation on the client device 202b to the user 204b, along with the search results 280. As another example, a video presentation system (not shown) may request video content items for presentation between programming segments. As another example, a social networking platform (not shown) may request textual and/or graphical content items for presentation within a news feed. As another example, a web page (not shown) may request a content item (e.g., a display advertisement) for presentation on the page. The request 254, for example, may include contextual information (e.g., search text including the phrase “used cars”), audience information, device information, and other information which may be used by the content management system 210 for selecting an appropriate content item.

The content item can be identified (406) from eligible content items. For example, the content management system 210 can use the content item identifier 214 to identify one or more content items, from eligible content items provided by various entities (e.g., “Example Motors”, a manufacturer of “Brand X”, a provider of “Unknown Vehicle Services”, etc.) and maintained by the content data store 232. In the present example, the content item identifier 214 may identify the content items 246 (e.g., the text phrases “Example Motors” and “We sell used cars!”) which have been provided by the campaign sponsor 240 for selection of content to be presented to users (e.g., the user 204b) having provided search text including the phrase “used cars”.

The content item can be evaluated (408). For example, the content management system 210 can use the content item evaluator 216 to determine whether a content item includes content that is associated with a branding label. In the present example, the content item evaluator 216 can evaluate the phrases “Example Motors” and “We sell used cars!” provided by the content sponsor 240. Evaluation of a content item, for example, may include evaluating the content (e.g., text parsing, image recognition, audio analysis, etc.) and/or may include evaluating metadata (e.g., data keys, submission information, file histories, etc.) associated with the content.

In some implementations, evaluating a content item may include identifying one or more products or services associated with the content item. For example, a content item including an image of a “Brand X” automobile model may be identified (e.g., using image recognition) by the content item evaluator 216 as being associated with “Brand X”. As another example, a content item including audio of an utterance of the phrase “Brand X” may be identified (e.g., using voice recognition) as being associated with “Brand X”. In some implementations, textual elements in a content item may be evaluated to identify one or more products or services associated with the content item. For example, if an identified content item were to include the text phrase “We sell Brand X vehicles!”, the content item evaluator 216 may parse the phrase to determine that the content item may be associated with “Brand X” automobiles. In some implementations, evaluating a content item may include identifying one or more trademarks included in the content item. For example, the content item evaluator 216 may determine (e.g., by referencing a public data source, such as a trademark database) whether “Brand X” is a registered trademark, and if so, may identify information associated with the trademark, such as a trademark owner, an associated image (e.g., a logo), and other potentially relevant information.

A determination (410) can be made of whether a content item includes content associated with a branding label. Branding labels, for example, may include images, and may include trademarks or service marks. In some implementations, determining whether a content item includes content that is associated with a branding label may include evaluating a dataset indexed by associated products or services. For example, if a representative of the campaign sponsor 240 (“Example Motors”) were to provide a content item including the phrase “We sell Brand X vehicles!”, the content item evaluator 216 may evaluate metadata (e.g., submission information) associated with the content item to identify a source of the content item. Using a source identifier (e.g., a data key), for example, the content item evaluator 216 can reference the branding data store 230 to identify the branding label 260 as potentially being applicable to the content item (e.g., based on the submission information), and the branding label 262 as potentially being applicable (e.g., based on products or services associated with the source of the content item). As another example, the content item evaluator 216 may evaluate textual elements included in the phrase “We sell Brand X vehicles!” to determine that the content item may be related to “Brand X”, and can reference the branding data store 230 to identify the branding label 262 as potentially being applicable to the content item (e.g., based on the content), and the branding label 260 as potentially being applicable (e.g., based on being a provider associated with the product or service).

In some implementations, determining whether a content item includes content associated with a branding label may include identifying keywords and/or phrases within the content item. For example, a textual content item may include a trademark symbol (e.g.,™,®, etc.). As another example, a textual content item may include a keyword and/or phrase (e.g., “Official Site”) recognized by the content item evaluator 216. Upon recognition of the symbol, keyword and/or key phrase, for example, the content item evaluator 216 may interpret the recognition as a directive to identify and apply an appropriate branding label.

When the content item includes content associated with a branding label, an appropriate branding label for the content item may be identified (412). In the present example, for a content item including the phrase “We sell Brand X vehicles!”, multiple branding labels (e.g., branding labels 260, 262) may be considered for application to the content item, as discussed in examples above and below. If, however, the content item does not include content associated with a branding label, in some examples the content item may be provided (414) without a branding label, responsive to the request.

In some implementations, a source of the content item and an owner associated with the branding label may be identified (416). In the present example, the content item evaluator 216 may determine that the source of the content item including the phrase “We sell Brand X vehicles!” is the campaign sponsor 240 (“Example Motors”). Considering each of the branding labels 260 and 262, for example, the content item evaluator 216 may determine that the owner of the branding label 260 is the campaign sponsor 240 (“Example Motors”), and that the owner of the branding label 262 is a manufacturer of “Brand X” automobiles. In some implementations, an application of a branding label to a content item may occur when the source of the content item matches the owner associated with the branding label. Thus, in the present example, as the source (“Example Motors”) of the content item under consideration matches the owner associated with the branding label 260, the branding label 260 may be applied. As the source of the content item in the present example does not match the owner associated with the branding label 262, however, the branding label 262 may not be applied.

In some implementations, verification of branding label ownership may occur if and when a branding label is provided by a campaign sponsor. For example, if a representative of the campaign sponsor 240 were to employ the user interface 300 (shown in FIG. 3) to attempt to upload the branding label 262 (i.e., a branding label owned by another entity), the content management system 210 may determine that the campaign sponsor 240 does not own and/or does not have permission to use the branding label 262, and thus may prevent the upload or otherwise inhibit use. By verifying that a campaign sponsor is authorized to be associated with a particular branding label, for example, the rights of branding label (e.g., trademark, service mark, etc.) owners may be protected, and system users (e.g., the user 204b) may be assured that campaign sponsors purporting to represent particular brands are authorized to do so.

In some implementations, prior to applying a branding label to a content item, a determination (418) may be made of whether a sponsor associated with the content item has designated that a branding label should be applied if available. In the present example, the campaign sponsor 240 may have previously indicated (e.g., via the user interface 300, shown in FIG. 3) that a particular branding label should be applied. As another example, a content sponsor may indicate that an appropriate branding label should be applied, and may direct the content management system 210 identify an appropriate branding label from the branding data store 230 or another appropriate source (e.g., a trademark database, etc.). If a campaign sponsor has designated that a branding label should be applied, for example, the process 400 may continue, based on the determination. However, if the campaign sponsor has not designated that a branding label should be applied, in some examples the content item may be provided (414) without the branding label, or the process may continue if a selection (e.g., an auction or reservation selection) is to be used to determine one or more content items for delivery.

In some implementations, an auction for selecting content items may be conducted, and a quality score associated with the content item may be adjusted (420) if the content item is associated with a branding label. For example, multiple different eligible content items may be identified by the content item identifier 214 as being suitable for presentation to the user 204b in response to the request 254 (e.g., a request for one or more content items to be provided along with search results relevant to the search string “used cars”), and an auction can be conducted to determine which among the eligible content items should be delivered. Quality scores, for example, may be based on historical click rates of the content items and other suitable factors. For example, a content item associated with a historically high click rate relative to other content items may receive a higher quality score than the other content items, whereas a content item associated with a historically low click rate relative to other content items may receive a lower quality score than the other content items. In some implementations, adjusting the quality score may include raising the quality score. For example, if a particular content item is associated with a branding label, and subject to potentially being selected as part of an auction including other content items that are not associated with branding labels, the quality score of the content item that is associated with the branding label may be raised (e.g., based on a predetermined formula, or by a predetermined percentage value).

In some implementations, applying a branding label and providing the content item along with the branding label may be subject to the content item being selected (422) as part of an auction. For example, the content management system 210 can use the auction manager 222 to evaluate bids provided by various campaign sponsors for having content presented to users in response to content requests. Campaign sponsors, for example, may bid on various phrases, terms, and/or prefixes that may be entered by users, or that may be included in content (e.g., web pages, maps, videos, articles, news feeds, social networking feeds, etc.) requested by and/or presented to users. During an auction, for example, the auction manager 222 can evaluate bids and associated quality scores for candidate items, and can determine one or more auction winners. If the content item is selected as part of an auction, for example, the process 400 may continue. However, if the content item is not selected, in some examples the process may end.

The branding label can be applied (424) to the content item. For example, the content management system 210 can use the branding label applicator 218 to apply a branding label to a content item to create a composite content item including one or more integrated text, image, video, audio, and/or link elements. In some implementations, applying a branding label to a content item may include determining a location on (or associated with) the content item to place the branding label. For example, the branding label applicator 218 can determine a location on the composite content item 270 for applying the branding label 260. An appropriate location for branding label placement, for example, may be influenced by elements (e.g., graphics, text, etc.) of the content item, and by presentation factors (e.g., screen size, screen resolution, refresh rate, etc.) of a client device and/or of an application for presenting the composite content item. For example, the window size of a particular presentation environment may be considered when formatting a composite content item so that the content item (e.g., text) and the branding label (e.g., image) are both visible, and that screen resources (e.g., screen area) are conserved.

In some implementations, determining a location for applying a branding label may include determining an acceptable location based on sponsor input. Referring to FIG. 3, for example, the control 330 may be provided to a campaign sponsor representative for indicating that a branding label is to be applied to a particular portion (e.g., left side, right side, top, bottom, etc.) of a composite content item to be presented to users. Input provided by a representative of the campaign sponsor 240, for example, can be maintained by the content management system 210 and can be used by the branding label applicator 218 when applying a branding label to a content item. In some implementations, determining a location may include determining an acceptable location that minimizes a portion of a content item that is obscured. For example, a favicon may generally be positioned to the right of a block of text (e.g., for English text) and may be placed such that an acceptable amount of whitespace is maintained between the text block and the favicon.

The content item can be provided (426) along with the branding label responsive to the request. For example, the content management system 210 can use the content item provider 220 to provide the composite content item 270 to the computing server(s) 208b, responsive to the request 254. In the present example, upon receiving the composite content item 270a, the computing server(s) 208b can integrate the content item with other content (e.g., a web page, a set of search results, a map, a video, an article, a social networking feed, etc.) to be provided to the user 204b. Alternatively, the composite content item 270a can be provided directly to the requesting device.

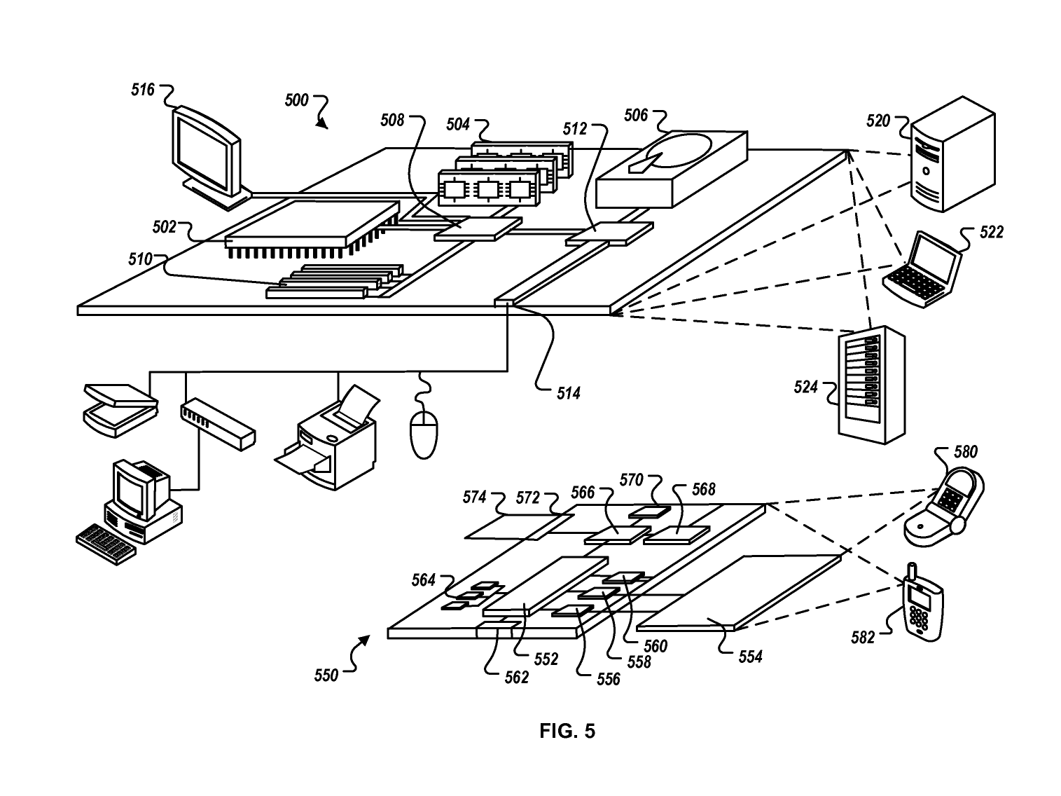

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
maintaining advertisements in a data store of advertisements, each given advertisement being associated with selection criteria for serving the given advertisement in response to received requests for advertisements and being associated with a bid for use in evaluating the given advertisement against other eligible advertisements responsive to a specific received request;
receiving a request for an advertisement to be presented to a user, wherein the request is associated with a slot on a resource and a received query, and wherein the advertisement is distinct from Internet search results generated from the received query;
selecting a particular advertisement from eligible advertisements in the data store of advertisements, based at least in part on the selection criteria associated with the advertisements;
evaluating, by one or more processors, the selected advertisement to determine when the selected advertisement includes content that is associated with a branding label, and when the selected advertisement is associated with a branding label, identifying an appropriate branding label for the selected advertisement;
automatically, by one or more processors, applying the appropriate branding label to the selected advertisement, wherein applying the appropriate branding label includes determining a location on the selected advertisement to place the appropriate branding label and placing the appropriate branding label at the determined location, wherein determining the location comprises identifying a text block within the selected advertisement, identifying a size of a window for display on a client device that is to present the selected advertisement, and positioning the appropriate branding label at a location relative to the text block that (i) maintains whitespace between the text block and the appropriate branding label and (ii) maintains both of the text block and the appropriate branding label at a visible location within the window of the client device, and wherein applying the appropriate branding label includes creating a composite content item based on content included in the selected advertisement that includes one or more integrated text, image, video, audio, or link elements; and
providing the composite content item that includes the appropriate branding label applied to the selected advertisement, responsive to the request.

2. The method of claim 1 wherein the selected advertisement includes only text and wherein the appropriate branding label is an image.

3. The method of claim 1 wherein the appropriate branding label is a trademark or service mark.

4. The method of claim 1 wherein evaluating the selected advertisement further includes identifying one or more products or services associated with the selected advertisement, and wherein identifying an appropriate branding label for the selected advertisement includes identifying a branding label associated with the identified products or services.

5. The method of claim 4 wherein evaluating the selected advertisement further includes evaluating textual elements in the selected advertisement to identify the one or more products or services associated with the selected advertisement.

6. The method of claim 4 wherein evaluating the selected advertisement includes identifying one or more trademarks included in the selected advertisement.

7. The method of claim 1 further comprising identifying a source of the selected advertisement and identifying an owner associated with the appropriate branding label, and wherein applying the appropriate branding label to the selected advertisement occurs when the source of the selected advertisement matches the owner associated with the branding label.

8. The method of claim 1 further comprising adjusting a quality score associated with an advertisement when the advertisement is associated with a branding label, and wherein applying the appropriate branding label to the selected advertisement and providing the selected advertisement that includes the appropriate branding label are subject to the selected advertisement being selected as part of an auction that is based at least in part on the adjusting.

9. The method of claim 8 wherein adjusting the quality score includes raising the quality score.

10. The method of claim 1 further comprising, prior to applying the appropriate branding label to the selected advertisement, determining that a sponsor associated with the selected advertisement has designated that a branding label should be applied when available, and wherein the appropriate branding label is applied based on the determination.

11. (canceled)

12. The method of claim 1 further comprising storing a dataset of branding labels indexed by associated products or services and wherein evaluating the selected advertisement to determine when the selected advertisement includes content that is associated with a branding label includes evaluating the dataset.

13. The method of claim 1 wherein the selected advertisement is a textual advertisement and wherein the appropriate branding label is an image.

14. (canceled)

15. The method of claim 1 wherein determining the location on the selected advertisement to place the appropriate branding label includes determining an acceptable location based at least in part on sponsor input.

16. The method of claim 1 wherein determining the location on the selected advertisement to place the appropriate branding label includes determining an acceptable location that minimizes a portion of the selected advertisement that is obscured.

17-19. (canceled)

20. A system comprising:
a content management system for serving sponsored content to users, the content management system including a data store of advertisements, a request receiver, a content item identifier, a content item evaluator, a branding label applicator, and a content item provider;
wherein the data store of advertisements maintains a plurality of advertisements, each given advertisement being associated with selection criteria for serving the given advertisement in response to received requests for advertisements and being associated with a bid for use in evaluating the given advertisement against other eligible advertisements responsive to a specific received request;
wherein the request receiver is enabled to receive a request for an advertisement to be presented to a user, wherein the request is associated with a slot on a resource and a received query, and wherein the advertisement is distinct from Internet search results generated from the received query;
wherein the content item identifier is enabled to select a particular advertisement from eligible advertisements in the data store of advertisements, based at least in part on the selection criteria associated with the advertisements;
wherein the content item evaluator is enabled to evaluate the selected advertisement to determine when the selected advertisement includes content that is associated with a branding label, and when the selected advertisement is associated with a branding label, to identify an appropriate branding label for the selected advertisement;
wherein the branding label applicator is enabled to automatically apply the appropriate branding label to the selected advertisement, wherein applying the appropriate branding label includes determining a location on the selected advertisement to place the appropriate branding label and placing the appropriate branding label at the determined location, wherein determining the location comprises identifying a text block within the selected advertisement, identifying a size of a window for display on a client device that is to present the selected advertisement, and positioning the appropriate branding label at a location relative to the text block that (i) maintains whitespace between the text block and the appropriate branding label and (ii) maintains both of the text block and the appropriate branding label at a visible location within the window of the client device, and wherein applying the appropriate branding label includes creating a composite content item based on content included in the selected advertisement that includes one or more integrated text, image, video, audio, or link elements; and
wherein the content item provider is enabled to provide the composite content item that includes the appropriate branding label applied to the selected advertisement, responsive to the request.

21. The system of claim 20 wherein the content item evaluator is enabled to identify a source of the selected advertisement and to identify an owner associated with the appropriate branding label, and wherein applying the appropriate branding label to the selected advertisement occurs when the source of the selected advertisement matches the owner associated with the branding label.

22. The method of claim 1 wherein the appropriate branding label is configured to change from a first visual appearance to a second, different, visual appearance in response to a user interaction with the appropriate branding label at the client device.
